(19) United States
(12) Patent Application Publication
(10) Pub. No.: US 2014/0347426 A1
(43) Pub. Date: Nov. 27, 2014

(54) LIQUID EJECTING HEAD

(71) Applicant: CANON KABUSHIKI KAISHA, Tokyo (JP)

(72) Inventors: Hiroyuki Murayama, Yokohama-shi (JP); Yoshinori Tagawa, Yokohama-shi (JP); Toshiaki Kurosu, Oita-shi (JP)

(73) Assignee: CANON KABUSHIKI KAISHA, Tokyo (JP)

(21) Appl. No.: 14/285,420

(22) Filed: May 22, 2014

(30) Foreign Application Priority Data
May 27, 2013 (JP) 2013-111343

(51) Int. Cl. B41J 2/175

(52) U.S. Cl. CPC B41J 2/175
USPC 347/85

(57) ABSTRACT

A liquid ejecting head includes a substrate; and flow path forming members that form a plurality of liquid flow paths on or above the substrate, wherein grooves are formed between the plurality of liquid flow paths that adjoin in a longitudinal direction of the substrate, and the flow path forming members are formed on or above the substrate via an intermediate layer.

### BACKGROUND OF THE INVENTION

1. Field of the Invention

The present invention relates to a liquid ejecting head.

2. Description of the Related Art

A liquid ejecting head is used in a liquid ejecting apparatus, such as an inkjet recording apparatus. The liquid ejecting head includes a substrate and a flow path forming member which is formed on the substrate. The flow path forming member forms a liquid flow path and, in some cases, an ejection port. A liquid supply port is formed in the substrate. The liquid supplied to the flow path from the liquid supply port is supplied with energy by an ejection energy generator which is provided in the substrate, and is ejected from the ejection port.

In such a liquid ejecting head, it is required that the flow path forming member is stably formed with respect to the substrate. As the length of the substrate increases, however, there is a possibility that the flow path forming member separates from the substrate due to stress produced by hardening of the flow path forming member and temperature changes. Separation tends to occur especially at end portions of the flow path forming member where the flow path forming member is thick and the stress is high.

Regarding separation of the flow path forming member from the substrate, Japanese Patent Laid-Open No. 2003-080717 describes forming a groove in the flow path forming member so as to surround the outside of the flow path and to divide the flow path forming member into an inner part and an outer part. It is also described that an edge portion of the groove is minutely serrated with many tiny protrusions and indentations. According to the method described in Japanese Patent Laid-Open No. 2003-080717, stress components are applied in various directions near the edge portion of the groove in the flow path forming member and some stress components cancel each other, and the like, whereby reduction of the stress applied to the flow path forming member can be expected.

### SUMMARY OF THE INVENTION

The present disclosure as described above is a liquid ejecting head including: a substrate; and flow path forming members that form a plurality of liquid flow paths on or above the substrate, wherein grooves are formed between the plurality of liquid flow paths that adjoin in a longitudinal direction of the substrate, and the flow path forming members are formed on or above the substrate via an intermediate layer.

Further features of the present invention will become apparent from the following description of exemplary embodiments with reference to the attached drawings.

### BRIEF DESCRIPTION OF THE DRAWINGS

FIGS. 1A to 1C are diagrams illustrating an example of a liquid ejecting head.

FIGS. 2A and 2B are diagrams illustrating an example of a liquid ejecting head.

FIGS. 3A to 3C are diagrams illustrating an example of a liquid ejecting head.

FIGS. 4A to 4C are diagrams illustrating an example of a liquid ejecting head.

### DESCRIPTION OF THE EMBODIMENTS

According to the study of the present inventors, it has been found that, in the method of Japanese Patent Laid-Open No. 2003-080717, there is a possibility that the flow path forming member separates from the substrate depending on the height of the stress. The stress tends to increase especially when the length of the substrate is large. Further, since the groove is formed to surround the flow path, the stress tends to be applied to four corners of the substrate, end portions of the flow path forming member, and the like, whereby there is a case in which the flow path forming member is separated.

The present disclosure provides a liquid ejecting head in which separation of flow path forming members from a substrate is desirably prevented.

A liquid ejecting head of the present disclosure will be described with reference to the drawings.

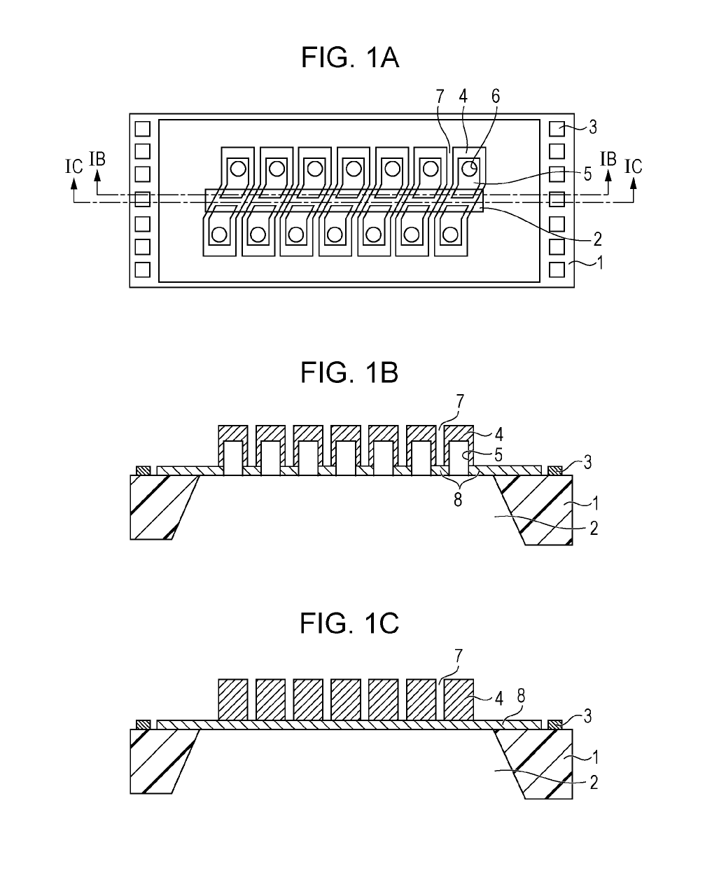

FIGS. 1A to 1C are diagrams illustrating an example of the liquid ejecting head of the present invention. FIG. 1A is a top view of the liquid ejecting head. FIG. 1B is a cross-sectional view of the liquid ejecting head along line IB-IB of FIG. 1A. FIG. 1C is a cross-sectional view of the liquid ejecting head along line IC-IC of FIG. 1A.

A substrate 1 is made of, for example, silicon and includes a liquid supply port 2. The liquid supply port 2 penetrates the substrate 1 from a front surface (an upper surface in FIGS. 1A to 1C) to a rear surface (a lower surface in FIGS. 1A to 1C). An unillustrated energy generator is formed on the front surface side of the substrate 1. The energy generator is supplied with electricity from a contact pad 3 which is electrically connected to the outside of the liquid ejecting head. Flow path forming members 4 are formed on or above the substrate 1. The flow path forming members 4 form a plurality of liquid flow paths 5 on or above the substrate 1. The plurality of liquid flow paths 5 are divided by the flow path forming members 4 and are formed as independent flow paths.

Ejection ports 6 are formed on or above the substrate 1. In FIG. 1A, the ejection ports 6 are formed in the flow path forming members 4. The ejection ports 6 may be formed in an ejection port forming member other than the flow path forming members 4. In this case, the ejection port forming member is disposed on the opposite side of the substrate 1 with respect to the flow path forming members 4.

The ejection ports 6 are arranged in the longitudinal direction of the substrate 1. In FIG. 1A, the ejection ports 6 are arranged in two arrays on both sides of the liquid supply port 2 in the longitudinal direction of the substrate 1. The longitudinal direction of the substrate 1 corresponds to the direction in which the ejection ports are arranged and corresponds to the left-right direction in FIGS. 1A to 1C.

Each flow path which constitutes the plurality of liquid flow paths 5 is formed to correspond to each ejection port 6. In FIG. 1A, one liquid flow path 5 is formed to correspond to one ejection port 6.

Grooves 7 are formed between the liquid flow paths 5 which adjoin in the longitudinal direction of the substrate 1. That is, a groove 7 is formed between a first flow path forming member 4 which forms a liquid flow path 5 and a second flow path forming member 4 which forms a liquid flow path 5 disposed next to the first flow path forming member 4.

An intermediate layer 8 is formed between the flow path forming members 4 and the substrate 1. That is, the flow path forming members 4 are formed on or above the substrate 1 via the intermediate layer 8.

As described above, in the configuration in which the groove 7 is formed between the liquid flow paths 5 which adjoin in the longitudinal direction of the substrate 1 and, in addition, the flow path forming members 4 are formed on or above the substrate 1 via the intermediate layer 8, the following effects are exhibited. That is, since walls formed by the flow path forming members 4 are independent from one another for each liquid flow path 5 and the flow path forming members 4 are not disposed continuously in the longitudinal direction of the substrate 1, the stress applied to the entire liquid ejecting head may be reduced. Especially in a case in which the length of the liquid ejecting head is increased and the substrate 1 is elongated in the longitudinal direction, the effect of reduction in stress becomes significant. Since the intermediate layer 8 alleviates the stress between the flow path forming members 4 and the substrate 1 and flow path portions are formed by the flow path forming members 4 and the intermediate layer 8, the volume of the flow path forming members 4 may be made small. Therefore, the stress applied to the entire liquid ejecting head may be reduced. In the present invention, these effects are exhibited interactively, whereby separation of the flow path forming members 4 from the substrate 1 may be desirably prevented.

A bottom surface of each groove 7 formed between the liquid flow paths 5 which adjoin in the longitudinal direction of the substrate 1 is desirably formed by the intermediate layer 8. Side walls of the groove 7 are desirably formed by the flow path forming members 4. With such a configuration, the stress of the entire liquid ejecting head may be further reduced. In FIGS. 1B and 1C, a groove 7 of which bottom surface is formed by the intermediate layer 8 and of which side walls are formed by the flow path forming members 4 is illustrated.

As described above, although the stress applied to the liquid ejecting head is reduced by the existence of the intermediate layer 8, the produced stress tends to be applied to interfaces between the flow path forming members 4 and the intermediate layer 8. Therefore, it is desirable that the intermediate layer 8 tends to absorb the stress. Specifically, it is desirable that the Young's modulus of the intermediate layer 8 is lower than the Young's modulus of the flow path forming members 4; for example, it is desirable that the Young's modulus of the intermediate layer 8 is equal to or lower than 90% of the Young's modulus of the flow path forming members 4.

The flow path forming members 4 may be made of an organic material or may be made of an inorganic material. The organic material to be used to form the flow path forming members 4 is desirably resin and more desirably photosensitive resin having photosensitivity. Specifically, epoxy resin and the like are used. Examples of the inorganic material to be used to form the flow path forming members 4 are SiN, SiC and SiO.

The intermediate layer 8 may be made of an organic material or may be made of an inorganic material. The organic material to be used to form the intermediate layer 8 is desirably resin and more desirably polyether amide and photosensitive resin having photosensitivity. Examples of the inorganic material to be used to form the intermediate layer 8 are SiN, SiC and SiO.

As is understood from FIGS. 1B and 1C, the height of the flow paths 5 is controllable by the thickness of the flow path forming members 4 and the thickness of the intermediate layer 8. In a case in which the height of the flow paths 5 is equal to or lower than 10 μm, if the flow path forming members 4 and the intermediate layer 8 are made of inorganic materials by using, for example, the chemical vapor deposition method, a basic process thereof is the same as a process of forming the substrate 1. For this reason, since the flow path forming members 4 and the intermediate layer 8 may be manufactured in a common manufacturing apparatus and in a common manufacturing process, it is desirable that the flow path forming members 4 and the intermediate layer 8 are made of inorganic materials. However, in a case in which the height of the flow paths 5 exceeds 10 μm, the time required to manufacture the flow path forming members 4 and the intermediate layer 8 becomes long. For this reason, it is desirable that the flow path forming members 4 and the intermediate layer 8 are made of organic materials.

Since the Young's modulus of an organic material is typically lower than the Young's modulus of an inorganic material by one or two digits, the stress produced in the substrate 1 may be further alleviated by not only making the intermediate layer 8 of an organic material but making the flow path forming members 4 of an organic material. Especially when the length of arrays of the ejection port 6 is increased or the size of the substrate 1 is reduced, deformation of the substrate 1 becomes large due to thermal changes and the like during an assembly process of the head or during the use of the head. Then, separation tends to occur due to changes greater than the extent to which adhesion between the substrate 1 and components on or above the substrate 1 can be maintained. Therefore, since both the intermediate layer 8 and the flow path forming members 4 which are formed on or above the substrate 1 are made of organic materials of which Young's modulus is lower than that of an inorganic material, deformation of the substrate 1 described above may be absorbed and adhesion reliability among the substrate 1, the intermediate layer 8 and the flow path forming member 4 may be further enhanced.

In a case in which the flow path forming members 4 are made of an organic material, depending on the liquid (for example, ink) to be used, there is a possibility that the ejecting direction and the ejecting amount are changed as a result of the change in the shape of the ejection ports 6 or the change in areas of the ejection ports 6 due to swelling of the organic material. From this viewpoint, it is desirable that the flow path forming members 4 are made of an inorganic material and the intermediate layer 8 which has a relatively small influence on the printing quality is made of an organic material.

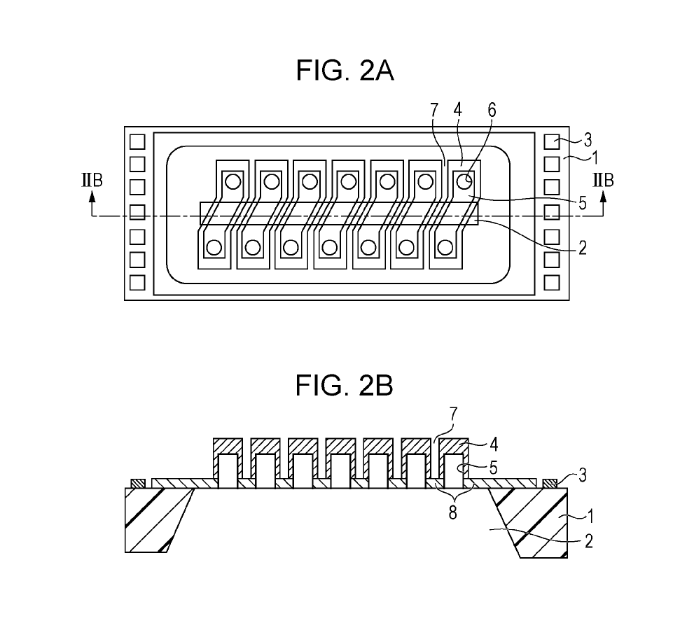

In FIG. 1A, the ejection ports 6 are arranged on both sides of the liquid supply port 2. The liquid is supplied from the liquid supply port 2, divided by the wall of the flow path forming members 4 on the liquid supply port 2, and then supplied to the pair of ejection ports 6 on the both sides on separate flow paths. Here, the wall provided in the flow path forming members 4 immediately above the liquid supply port 2 to divide the liquid into individual flow paths may be omitted. A top view of the liquid ejecting head of this configuration is illustrated in FIG. 2A. FIG. 2B is a cross-sectional view of the liquid ejecting head along line IIB-IIB of FIG. 2A. In the liquid ejecting head as illustrated in FIGS. 2A and 2B, no groove is formed between the flow paths 5 in the width direction across the supply port 2. Although an effect of alleviating the stress against deformation of the substrate 1 in the longitudinal direction is substantially the same as that of the liquid ejecting head as illustrated in FIGS. 1A to 1C, an effect of alleviating the stress against deformation of the substrate 1 in the width direction is slightly low. However, since there is no wall which divides the liquid into the pair of ejection ports 6 on the both sides on the liquid supply port 2, substantially all the openings of the liquid supply port supply the liquid to one liquid path, whereby liquid supplying performance is increased.

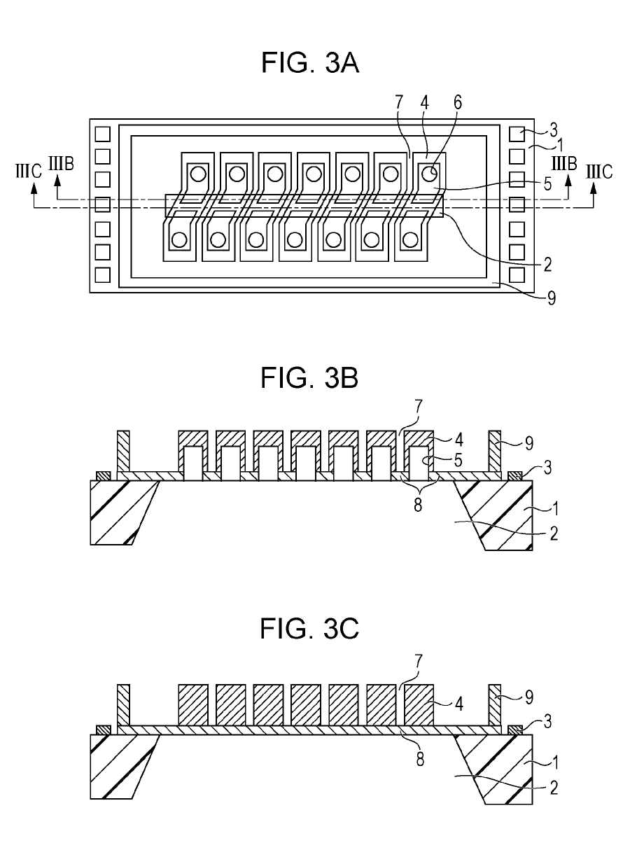

It is also desirable that the liquid ejecting head of the present invention includes a peripheral member in an outer position with respect to the flow path forming members 4 in the longitudinal direction of the substrate 1. The peripheral member is disposed to surround the flow path forming members 4. A top view of the liquid ejecting head which includes the peripheral member is illustrated in FIG. 3A. FIG. 3B is a cross-sectional view of the liquid ejecting head along line IIIB-IIIB of FIG. 3A. FIG. 3C is a cross-sectional view of the liquid ejecting head along line IIIC-IIIC of FIG. 3A.

The liquid ejecting head illustrated in FIGS. 3A to 3C includes the peripheral member 9 which is disposed to surround the flow path forming members 4 when the liquid ejecting head is seen from the front surface side. The peripheral member 9 is made of substantially the same material as that of the flow path forming members 4. The term “substantially the same material” means the material having substantially the same basic constituent and thus differences caused by a manufacturing error and the like will be ignored. For example, if one member made of a certain material is patterned and divided into the flow path forming members 4 and the peripheral member 9, the peripheral member 9 and the flow path forming members 4 are made of substantially the same material. The front surfaces of the flow path forming members may be in contact with a blade when wiping is performed using the blade and the like. Since the grooves 7 are formed in the flow path forming members 4 of the liquid ejecting head of the present invention, pressure of the blade and the like may be applied to the grooves 7. In this regard, if the peripheral member 9 is formed, the blade and the like is brought into contact with the peripheral member 9, whereby strong pressure by the blade and the like applied to the grooves 7 of the flow path forming members 4 may be prevented. Further, the degree of pressure by the blade and the like may be made more uniform at the central portions and the end portions of the flow path forming members 4. In this manner, separation of the flow path forming members 4 from the substrate 1 due to the pressure of the blade and the like may be desirably prevented. It is desirable that the height of an upper surface of the peripheral member 9 from a surface of the substrate 1 is equal to or greater than the height of upper surfaces of the flow path forming members 4 from the surface of the substrate 1. If the height of the peripheral member 9 is excessively great, there is a possibility that the blade and the like is not brought into contact with the surfaces of the flow path forming members 4. From this reason, it is desirable that the height of the upper surface of the peripheral member 9 from the surface of the substrate 1 is 1 time or more and 1.5 times or less of the height of the upper surfaces of the flow path forming members 4 from the surface of the substrate 1.

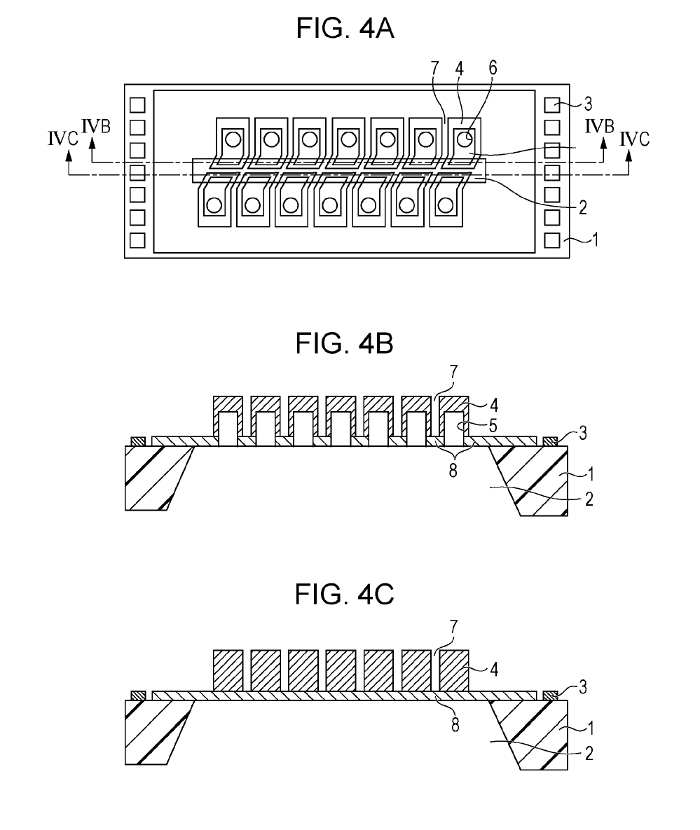

Although the grooves 7 are formed between the liquid flow paths 5 which adjoin in the longitudinal direction of the substrate 1, it is also possible to form grooves between the liquid flow paths 5 which adjoin in the width direction of the substrate 1. Such a liquid ejecting head is illustrated in FIGS. 4A to 4C. FIG. 4A is a top view of the liquid ejecting head. FIG. 4B is a cross-sectional view of the liquid ejecting head along line IVB-IVB of FIG. 4A. FIG. 4C is a cross-sectional view of the liquid ejecting head along line IVC-IVC of FIG. 4A. Grooves 7 are formed between a first flow path forming member 4 which forms a liquid flow path 5 and a second flow path forming member 4 which forms a liquid flow path 5 disposed next to the first flow path forming member 4 in the longitudinal direction and between the first flow path forming member 4 and a third flow path forming member 4 which forms a liquid flow path 5 disposed next to the first flow path forming member 4 in the width direction. In such a configuration, since walls formed by the flow path forming members 4 for each liquid flow path 5 are independent from one another and the flow path forming members 4 are not disposed continuously in the longitudinal direction and in the width direction of the substrate 1, the stress applied to the entire liquid ejecting head may be further reduced.

According to the present invention, a liquid ejecting head in which separation of flow path forming members from a substrate is desirably prevented can be provided.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-111343, filed May 27, 2013 which is hereby incorporated by reference herein in its entirety.

What is claimed is:

1. A liquid ejecting head comprising: a substrate; and flow path forming members that form a plurality of liquid flow paths on or above the substrate, wherein
grooves are formed between the plurality of liquid flow paths that adjoin in a longitudinal direction of the substrate, and the flow path forming members are formed on or above the substrate via an intermediate layer.

2. The liquid ejecting head according to claim 1, wherein bottom surfaces of the grooves are formed by the intermediate layer.

3. The liquid ejecting head according to claim 1, wherein side walls of the grooves are formed by the flow path forming members.

4. The liquid ejecting head according to claim 1, wherein a Young's modulus of the intermediate layer is less than a Young's modulus of the flow path forming members.

5. The liquid ejecting head according to claim 1, wherein a peripheral member made of a material substantially the same as that of the flow path forming members is formed in an outer position with respect to the flow path forming members in the longitudinal direction of the substrate.

6. The liquid ejecting head according to claim 1, wherein grooves are formed between the plurality of liquid flow paths that adjoin in a width direction of the substrate.

7. The liquid ejecting head according to claim 1, wherein the flow path forming members and the intermediate layer are made of organic materials.

8. The liquid ejecting head according to claim 1, wherein the flow path forming members and the intermediate layer are made of inorganic materials.

9. The liquid ejecting head according to claim 1, wherein the flow path forming members are made of an inorganic material and the intermediate layer is made of an organic material.
